(19) United States
(12) Patent Application Publication
(10) Pub. No.: US 2026/0157588 A1
(43) Pub. Date: Jun. 11, 2026

(54) VACUUM CLEANER WITH SELF-CLEANING FUNCTION

(71) Applicant: Dongguan Comfort Electrical Industrial Co., Ltd., Dongguan (CN)

(72) Inventors: Anming FU, Dongguan (CN); Guanzhong FU, Dongguan (CN); Yanzhe FU, Dongguan (CN)

(21) Appl. No.: 19/011,467

(22) Filed: Jan. 6, 2025

(30) Foreign Application Priority Data
Dec. 10, 2024 (CN) 202411812982.4

(51) Int. Cl. A47L 9/20; A47L 9/12; B01D 46/24; B01D 46/48; B01D 46/71; B01D 46/76

(52) U.S. Cl. CPC A47L 9/20; A47L 9/127; B01D 46/2411; B01D 46/48; B01D 46/71; B01D 46/76; B01D 2279/55

(57) ABSTRACT

Disclosed is a vacuum cleaner with a self-cleaning function, including: a dust cup, where the dust cup is provided with an air inlet, and the air inlet is connected to an air intake duct; a host, where a suction assembly and a control assembly are arranged in the host, the host is provided with an air outlet and a suction inlet, the dust cup is connected to the host, and the suction assembly is connected to the control assembly; a filter element mounted in the dust cup, where a channel is formed between the filter element and the host, and external dusty air enters the dust cup and then enters the host and is discharged outward; and a dust-blowing cleaning mechanism, where the dust-blowing cleaning mechanism blows out clean air, and the clean air passes through the filter element and blows off dust and impurities.

### CROSS-REFERENCE TO RELATED APPLICATION

This application claims priority of Chinese Patent Application No. 202411812982.4, filed on Dec. 10, 2024, the entire contents of which are incorporated herein by reference.

### TECHNICAL FIELD

The present disclosure belongs to the technical field of vacuum cleaners and specifically relates to a vacuum cleaner with a self-cleaning function.

### BACKGROUND

There are various types of vacuum cleaners with large and small sizes, which have line-shaped, T-shaped, or 7-shaped structures. Apart from intelligent robotic vacuum cleaners, most handheld vacuum cleaners are operated by holding the vacuum cleaners with hands. A handheld vacuum cleaner includes a handle and a host head, a fan is arranged on the host head, a dust cup is arranged at a suction end of the fan, a suction hole corresponding to the suction end of the fan is formed in the host head, an exhaust hole corresponding to an exhaust end of the fan is formed in the host head, and the suction hole is arranged to be communicated with the dust cup. A filter element is generally arranged in the dust cup, and the filter element is usually made of a material with micropores on its surface. When airflow passes through the dust cup, the filter element can intercept solid waste in the dust cup, thereby achieving collection of the solid waste. After long-term use of the vacuum cleaner, dust is accumulated on a surface of the filter element, and the dust will block micropores on the surface of the filter element, such that suction power of the vacuum cleaner is reduced, thereby necessitating regular replacement of the filter element by a user. The frequent replacement imposes more cost burden on the user. Therefore, the user can choose to clean the filter element. To clean the filter element, the user needs to remove the dust cup from the host of the vacuum cleaner, then take the filter element out of the dust cup, and remount the filter element and the dust cup back into the host of the vacuum cleaner after cleaning. This operation process is extremely cumbersome, and the user's hands and surrounding environment will be contaminated in the process of cleaning the filter element, thereby affecting user experience.

### SUMMARY

In order to solve the above technical problems, the present disclosure provides a vacuum cleaner with a self-cleaning function.

In order to solve the above technical problems, the present disclosure adopts the following technical solution:
A vacuum cleaner with a self-cleaning function, including:
   a dust cup, where the dust cup is provided with an air inlet, and the air inlet is connected to an air intake duct;
   a host, where a suction assembly and a control assembly are arranged in the host, the host is provided with an air outlet and a suction inlet, the dust cup is connected to the host, and the suction assembly is connected to the control assembly;
   a filter element, where the filter element is mounted in the dust cup, a channel is formed between the filter element and the suction inlet of the host, and external dusty air enters the dust cup through the air intake duct and then enters the host after flowing through the filter element and is discharged outward through the air outlet of the host;
   and a dust-blowing cleaning mechanism, where the dust-blowing cleaning mechanism is arranged in the channel between the filter element and the host, the dust-blowing cleaning mechanism blows out clean air, and the clean air passes through the filter element and blows off dust and impurities from a surface of the filter element.

As a further improvement, the channel formed between the filter element and the suction inlet of the host is a sealed space, and air can only pass through the filter element.

As a further improvement, the channel formed between the filter element and the suction inlet of the host has gaps, and the air passes through both the gaps and the filter element.

As a further improvement, the dust cup is provided with a filter cartridge support, a top of the filter cartridge support is connected to the host, a filter net is arranged on a side wall of the filter cartridge support, the filter element is located in the filter cartridge support, and external dusty air enters the filter element after passing through the filter net.

As a further improvement, the dust-blowing cleaning mechanism includes a blower motor, the blower motor is provided with an air duct, and the air duct penetrates through both ends of the blower motor.

As a further improvement, a motor support is arranged on the host, the blower motor is mounted in the motor support, and the motor support extends into the channel.

As a further improvement, the blower motor includes an inner shell and an outer shell, the inner shell and the outer shell are connected by a connecting rib, and the air duct is formed between the inner shell and the outer shell.

As a further improvement, the dust cup is provided with a vibration cleaning mechanism, the vibration cleaning mechanism is connected to the control assembly, and the vibration cleaning mechanism drives the filter element to vibrate.

As a further improvement, the vibration cleaning mechanism includes a vibration motor and an eccentric wheel, the eccentric wheel is connected to a drive shaft of the vibration motor, and the vibration motor drives the eccentric wheel to rotate and intermittently collide with the filter element so as to induce vibration of the filter element.

As a further improvement, a bottom surface of the filter element is provided with a bottom cover, a support column is arranged inside the bottom cover, the eccentric wheel is located on a side surface of the support column, the vibration motor drives the eccentric wheel to rotate to periodically collide with the support column at an interval, and the filter element is driven to vibrate; and alternatively, the eccentric wheel and the filter element can directly collide with each other periodically at an interval, such that the filter element vibrates.

As a further improvement, the vibration cleaning mechanism includes a vibration cylinder and a top block, wherein the top block is connected to a piston of the vibration cylinder, and the vibration cylinder drives the top block to move back and forth in a telescopic manner to collide with the filter element, which drives the filter element to vibrate.

Compared with the prior art, the present disclosure has the following beneficial effects:
The blower motor is directly mounted in the channel between the filter element and the suction inlet, the blower motor directly blows air toward the filter element, all areas of the filter element can be blown and cleaned by the air, the air is blown from the inner surface of the filter element, and when the air is blown outward from the filter element, the dust attached to the surface of the filter element can be blown off; and in combination with the vibration for dust removal, the filter element is driven to vibrate, such that the dust attached to the surface of the filter element can be 0removed by vibration; and in further combination with dust sweeping by air blowing, the dust attached to the surface of the filter element can be removed in a more thorough manner, which prevents the dust shaken off by vibration from being reattached to the surface of the filter element, thereby reducing the frequency of manually disassembling, cleaning and replacing the filter element, and reducing use costs while enhancing user experience.

### BRIEF DESCRIPTION OF THE DRAWINGS

FIG. 1 is a schematic diagram of a three-dimensional structure of the present disclosure.

FIG. 2 is a schematic diagram of a sectional structure of Example 1 of the present disclosure.

FIG. 3 is a partial exploded view of Example 1 of the present disclosure.

FIG. 4 is a structural schematic diagram of assembling a vibration cleaning mechanism and a filter element in Example 2 of the present disclosure.

FIG. 5 is a structural schematic diagram of assembling a vibration motor and a filter element 0in Example 2 of the present disclosure.

FIG. 6 is a structural schematic diagram of assembling a vibration cylinder and a filter element in Example 3 of the present disclosure.

FIG. 7 is a schematic diagram of a three-dimensional structure of a blower motor of the present disclosure.

FIG. 8 is a structural schematic diagram of assembling a filter element and a filter cartridge support of the present disclosure.

FIG. 9 is a schematic diagram of a breakdown structure of FIG. 8.

### REFERENCE NUMERALS IN FIGURES

Host 1, dust cup 2, air intake duct 3, air outlet 4, cover plate 5, handle 6, filter element 7, blower motor 8, outer shell 81, inner shell 82, air duct 9, suction assembly 10, suction inlet 11, channel 12, filter cartridge support 13, motor support 14, filter net 15, vibration motor 16, eccentric wheel 17, bottom cover 18, support column 19, vibration cylinder 20, and top block 21.

### DETAILED DESCRIPTIONS OF THE EMBODIMENTS

Implementations of the present disclosure are described in detail below, examples of the implementations are shown in accompanying drawings, throughout which identical or similar reference numerals denote identical or similar elements or elements having identical or similar functions. The implementations described with reference to the accompanying drawings are exemplary and only intended to explain the present disclosure, instead of being construed as limiting the present disclosure.

In the description of the present disclosure, it should be understood that the related terms “center”, “longitudinal”, “lateral”, “length”, “width”, “thickness”, “upper”, “lower”, “front”, “rear” , “left”, “right”, “vertical”, “horizontal”, “top”, “bottom”, “inner”, “outer”, “clockwise”, “counterclockwise”, and other indicated orientations or positional relationships are based on the orientations or positional relationships shown in the accompanying drawings, and are only for the convenience of describing the present disclosure and simplifying the description, rather than indicating or implying that indicated devices or elements must have a particular orientation, be constructed and operate in a particular orientation and are therefore not to be construed as limitations of the present disclosure. Furthermore, the terms “first” and “second” are merely for the purpose of description, and cannot be construed as indicating or implying relative importance or implicitly specifying the number of technical features indicated. Thus, a feature defined with “first” and “second” may explicitly or implicitly include one or more of the features. In the description of the present disclosure, “a plurality of” means two or more, unless expressly specified otherwise.

In the description of the present disclosure, it should be noted that unless otherwise explicitly specified and defined, the terms “mounted”, “connected” and “fixed” should be understood in a broad sense. For example, fixed connection, detachable connection or integral connection can be used. Mechanical connection or electrical connection can be used. Direct connection, indirect connection via an intermediate medium or interior communication of two elements can be used. The specific meanings of the above terms in the present disclosure may be understood on a case-by-case basis for those of ordinary skill in the art.

A vacuum cleaner is a commonly used cleaning tool, and a main structure of the vacuum cleaner includes components such as a fan, a dust cup, and an air intake duct, where a filter is mounted inside the dust cup, the air intake duct is connected to the dust cup, and the dust cup is connected to the fan. When the fan sucks air, a vacuum negative pressure environment is formed in the dust cup, an external airflow is sucked in, the airflow enters the dust cup through the air intake duct, and then enters the filter, and the filter is capable of intercepting solid waste carried in the airflow in the dust cup, so as to achieve collection of the waste.

The present disclosure primarily improves and innovates a filter element part, and the filter element is a necessary structure in various types of vacuum cleaners. Therefore, the present disclosure can be applied not only to handheld vacuum cleaners, but also to floor-standing vacuum cleaners, car-mounted vacuum cleaners, and sweepers.

### EXAMPLE 1

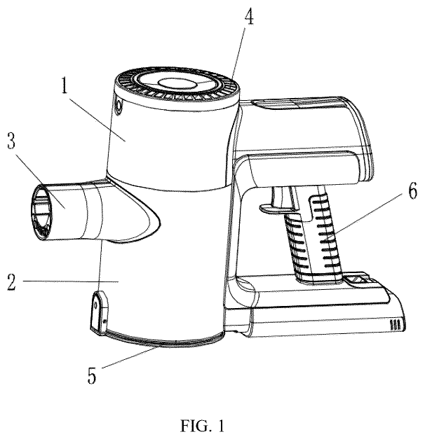

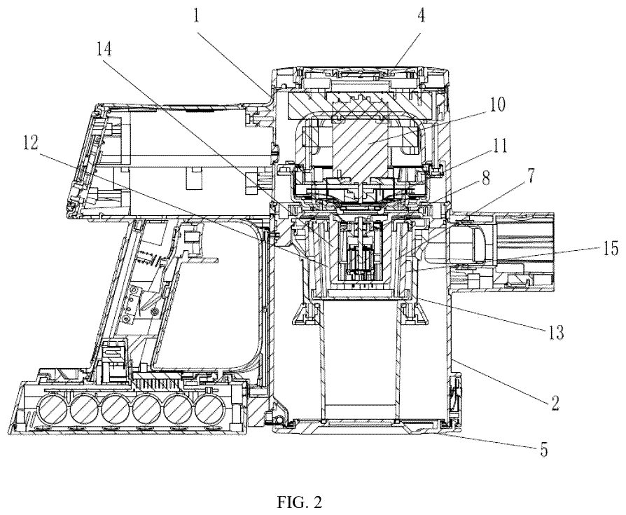

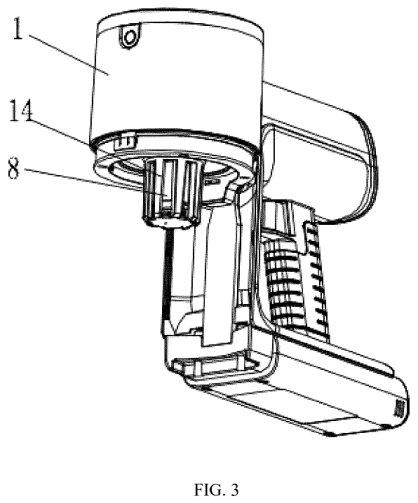

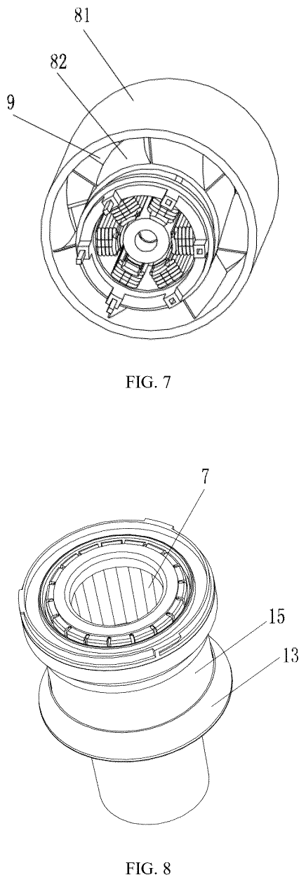

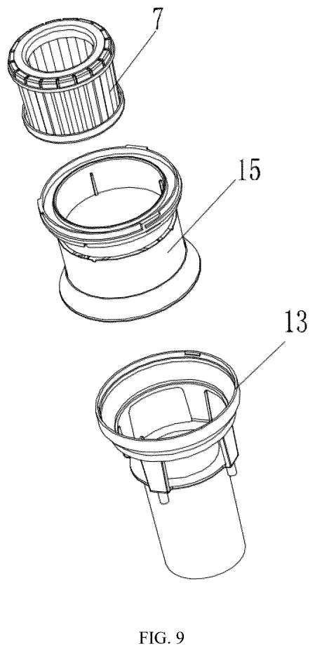

With reference to FIGS. 1-3 and 7-9, a vacuum cleaner with a self-cleaning function includes a host 1, a dust cup 2, a filter element 6, and a dust-blowing cleaning mechanism, where:
a suction assembly 10 and a control assembly are arranged in the host 1, the host 1 is provided with an air outlet 4 and a suction inlet 11, and the suction assembly 10 is connected to the control assembly. The suction assembly is usually a fan, and when the fan is activated, air suction starts, such that external air is sucked in. The control assembly includes a necessary PCB board, wires and the like, as well as a power module, which can be a battery, enables wireless operation, and achieves control over start and stop of the suction assembly, and also operating power. The host can be designed to have different shapes according to various needs for different target users. To facilitate control, a control button may be further arranged, and is connected to the control assembly for starting and stopping the suction assembly.

A bottom surface of the dust cup 2 can be connected to a cover plate 5, and the cover plate 5 can be opened to dump out dust and debris inside the dust cup 2. The dust cup 2 is provided with an air inlet, and the air inlet is connected to an air intake duct 3. An upper end of the dust cup 2 is connected to the host 1, and the two are mounted and fixed through a threaded or snap-fit structure, or through any other method. A lower end of the dust cup 2 is configured for mounting the cover plate 5, one side of the cover plate 5 is connected to one side of the bottom surface of the dust cup 2 in a hinged manner, to achieve rotation of the cover plate 5, and a snap latch is arranged on the other side surface of the dust cup to fasten the cover plate, which facilitates opening and closing of the cover plate. When the cover plate is opened, dust and debris accumulated in the dust cup can be discharged. In this example, the air intake duct is arranged vertically on a side wall of the dust cup. But this structure is not limited thereto, and the air intake duct can also extend to be parallel to or form any other angle against the dust cup.

The filter element 7 is mounted in the dust cup, and a channel 12 is formed between the filter element 7 and the suction inlet 11 of the host 1. When the suction assembly in the host 1 is activated, air is sucked, such that a vacuum negative pressure environment is formed in the channel 12, external dusty air enters the dust cup through the air intake duct and then enters the channel 12 through the filter element, and the filter element filters the dusty air, such that dust and impurities in the dusty air are isolated and attached to a surface of the filter, and the filtered air then enters the host through the suction inlet and is discharged outward through the air outlet of the host.

The dust-blowing cleaning mechanism is located in the channel 12, the dust-blowing cleaning mechanism includes a blower motor 8, the blower motor 8 is provided with an air duct 9, and the air duct 9 penetrates through both ends of the blower motor 8. The blower motor 8 is directly embedded in the channel 12, the blower motor 8 blows air directly, and blown air reaches a surface of the filter element 7 and blown outward from an inner surface of the filter element 7, such that all areas of the filter element can be blown and cleaned, so as to remove dust attached to the surface of the filter element 7. The blower motor 8 operates after a dust suction action is completed to prevent mutual interference. When the suction assembly sucks air, the air entering the filter element 7, after passing through the channel 12, flows upward through the air duct 9 in the blower motor 8, and finally enters the host and is discharged through the air outlet. As air is directly blown to the filter element 7, an effect of cleaning the filter element is enhanced. A blowing button can be separately arranged on the host, the blowing button is connected to the control assembly, the blower motor is also connected to the control assembly, or a control panel can be separately arranged to control the blower motor. A user can turn on or off the blower motor by pressing the blowing button. The blowing button can be arranged at any position of the host to facilitate operation by the user.

Moreover, for a handheld vacuum cleaner, the host can be provided with a handle, and a dust suction button and the blowing button can be arranged on the handle respectively for ease of operation. For any other non-handheld vacuum cleaner, the handle may not be arranged.

The filter element can be made from fiberglass, polypropylene, or any other filtering material, and these materials have fine fiber structures, and are capable of effectively capturing airborne particles in air such as dust, pollen, bacteria and the like, thereby improving air purification efficiency.

A specific assembly method of the filter element can be flexibly selected based on actual application scenarios.

Moreover, a specific structure of the filter element can be cylindrical, flat, or arc-shaped, or in any other shape. During assembly, it is only required that the filter element is first in contact with the dusty air entering the dust cup from the air intake duct, and it is ensured that the dusty air in the dust cup can enter the channel 12 after passing through the filter element 7, to exert a filtering effect.

### Method I

The channel 12 formed between the filter element 7 and the suction inlet 11 of the host 1 is a sealed space, the suction inlet is located in an inner area of the channel 12, and air can only pass through the filter element 7. That is, in a dust suction state, external dusty air, after entering the dust cup, can only pass through the filter element 7 before entering the channel 12, then enters the host 1 through the suction inlet 11, and finally is discharged from the air outlet 4. In a self-cleaning state, air blown out by the blower motor 8 also can only blow and clean the inner surface of the filter element 7, and then be blown outward through the filter element 7. A sealing structure of the channel can be formed by directly connecting the filter element 7 to the host in a fitted manner or by using a connector to connect the filter element and the host.

The channel 12 is arranged to have a sealed space, air blown out by the blower motor has a good effect of blowing and cleaning the filter element, and the air is blown to the surface of the filter element 7 in a concentrated manner.

### Method II

The channel 12 formed between the filter element 7 and the suction inlet 11 of the host 1 has gaps, the gaps can be located in different areas of the channel, and the air passes through both the gaps and the filter element. In this structure, due to presence of gaps, a small portion of the air blown out by the blower motor 8 flows out of the gaps, and therefore, the air cannot be utilized to a maximum extent for cleaning the filter element 7. However, this structure also enables to achieve cleaning of the filter element 7 in a way of blowing, and this method is relatively inferior to Method I in effect.

Moreover, to facilitate mounting of the filter element 7, the dust cup 2 is provided with a filter cartridge support 13, a top of the filter cartridge support 13 is connected to the host 1 to form a sealed connection, a filter net 15 is arranged on a side wall of the filter cartridge support 13, the filter element 7 is located in the filter cartridge support 13, a certain gap is formed between the filter element 7 and the filter net 15, external dusty air enters the filter element 7 after passing through the filter net 15, and a bottom surface of the filter element 7 is not fixed. The filter net 15 can be made of stainless steel or any other material, the filter net surrounds by a circle, the filter element is located in the filter net, and holes on the filter net are larger than those on the filter element, thereby facilitating coarse filtration. After external dusty air passes through the filter net, larger impurities are blocked first, and the inner filter element mainly filters out smaller particles such as dust and impurities.

A lower end of the filter cartridge support 13 can extend to a bottom of the dust cup 2. Inside of the filter cartridge support 13 is hollow in an axial direction. During mounting, the filter element can be connected to the host first in an assembled manner, then the filter cartridge support is mounted, and the filter element is accommodated inside.

A motor support 14 is arranged on the host 1, the blower motor 8 is mounted in the motor support 14, the motor support 14 extends into the channel 12, and the motor support 14 can be integrally formed with the host 1. The motor support 14 can be cylindrical, and an opening is formed on a side wall thereof to facilitate air circulation.

The blower motor 8 includes an inner shell 82 and an outer shell 81, the inner shell 82 and the outer shell 81 are connected by a connecting rib, and the air duct 9 is formed between the inner shell 82 and the outer shell 81. Stators, rotors, fan blades and other components required for operation are mounted in the inner shell. An outer surface of the outer shell is fitted and fastened to an inner wall of the motor support. A gap is formed between a lower end of the blower motor and the bottom surface of the filter element to ensure normal air circulation and blowing.

During dust suction, external dusty air enters the dust cup through the air intake duct, then first passes through the filter net 15, then enters the channel 12 and the host 1 through the suction inlet 11, and finally is discharged from the air outlet 4 of the host 1. After the dust suction is stopped, the blower motor 8 can be activated, the blower motor 8 blows air, the air is directly blown toward the surface of the filter element 7 or blown toward the filter element 7 after rebounding against any other position, the surface of the filter element is blown, and the air is blown outward through the inner surface of the filter element 7, such that the dust and impurities attached to the surface of the filter element can be removed, thereby achieving an effect of cleaning the filter element.

### EXAMPLE 2

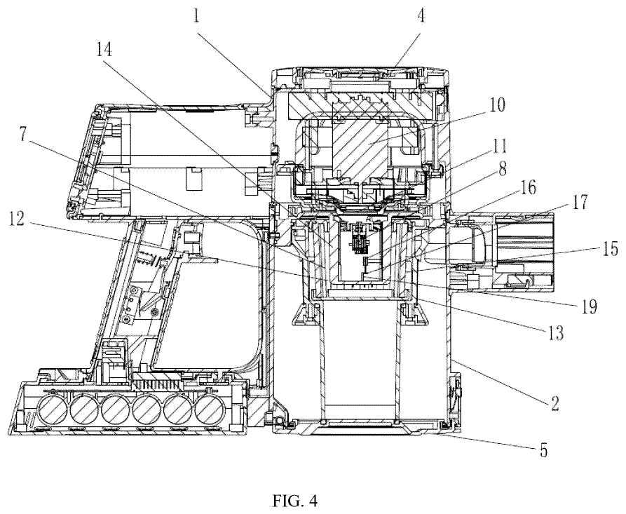

With reference to FIGS. 1-5, based on Example 1, the dust cup 2 is provided with a vibration cleaning mechanism, the vibration cleaning mechanism is connected to the control assembly, and the vibration cleaning mechanism drives the filter element to vibrate. A vibration control button can be separately arranged on the host or the handle to start or stop the vibration cleaning mechanism.

The vibration cleaning mechanism includes a vibration motor 16 and an eccentric wheel 17, the eccentric wheel 17 is connected to a drive shaft of the vibration motor 16, and the vibration motor 16 drives the eccentric wheel 17 to rotate and intermittently collide with the filter element 7 so as to induce vibration of the filter element. The bottom surface of the filter element 7 is provided with a bottom cover 18, a support column 19 is arranged inside the bottom cover 18, the eccentric wheel 17 is located on a side surface of the support column 19, the bottom cover 18 is inside the filter cartridge support 13 but is not in contact with an inner wall of the filter cartridge support 13, and there exists a certain gap, which facilitates swinging of the bottom cover 18. The vibration motor 16 drives the eccentric wheel 17 to rotate to periodically collide with the support column 19 at an interval, the filter element 7 is driven to vibrate, and both the eccentric wheel 17 and the support column 19 can be made of silica gel or any other elastic material. Each time when the eccentric wheel collides with the support column, the bottom cover is driven to swing slightly, which further causes the entire filter element to swing slightly. A range of the swing can be chosen based on a size of a product and a spatial range formed after assembly of the filter element, and it is only required to set a contact travel between the eccentric wheel and the support column.

Alternatively, the eccentric wheel and the filter element can directly collide with each other periodically at an interval, such that the filter element vibrates. For example, a side wall of the filter element can be directly collided, or an edge of the top of the filter element can be collided. Of course, at the bottom cover of the bottom surface of the filter element, the support column can be used for the colliding, and it can be seen that a best vibration effect is achieved due to an effect of transmission by a lever and force. A point of vibration at the side wall or top of the filter element is closer to a fixed position of the top of the filter element, and therefore, the vibration effect is weaker.

Based on a set periodic frequency, rapid intermittent collisions can be achieved to create a resonance-like effect, such that the dust and impurities attached to the surface of the filter element can be removed by vibration.

During assembly, the vibration motor can be mounted in the motor support together with the blower motor, but the spatial size needs to be considered, and the vibration motor of an appropriate size needs to be selected to avoid mutual interference with the blower motor. For example, the blower motor can extend downward to a middle position of the filter element, the support column is located at a bottom of the filter element, and the eccentric wheel of the vibration motor can be located below the lower end of the blower motor, thereby preventing the mutual interference.

### EXAMPLE 3

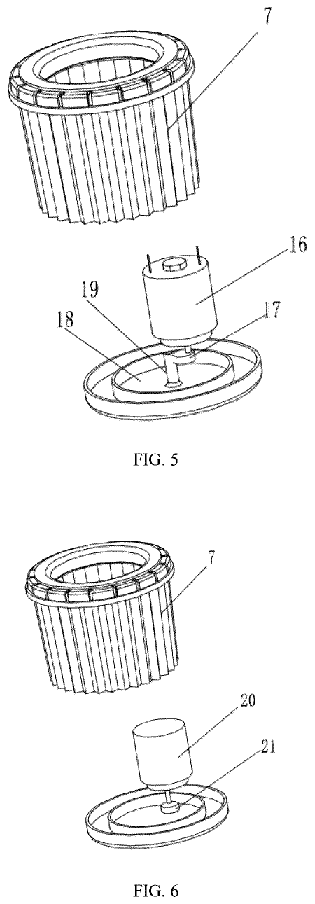

With reference to FIGS. 1-3 and 6, based on Example 1, the vibration cleaning mechanism can have an alternative structure, including a vibration cylinder 20 and a top block 21, where the top block 21 is connected to a piston of the vibration cylinder 20, and the vibration cylinder drives the top block to move back and forth in a telescopic manner to collide with the filter element, which drives the filter element to vibrate. Rapid back-and-forth movements of the vibration cylinder drives the top block to frequently collide with the filter element to achieve effects of resonating, vibration and dust shaking.

The vibration cylinder is arranged horizontally, which drives the top block to collide with the filter element in a horizontal direction, or collide with the side wall or other positions of the filter element; and alternatively, the vibration cylinder can be arranged vertically, which drives the top block to collide with the filter element in a vertical direction and collide with the bottom cover 18 of the bottom surface of the filter element 7, thereby achieving vibration.

The vibration cylinder can be mounted in the motor support without interference with the blower motor.

The blower motor, the vibration motor, or the vibration cylinder can share the power module in the host. The blower motor, the vibration motor, or the vibration cylinder are defined with such names merely for convenience of distinction and do not refer to specific models of motors and cylinders.

During use, a self-cleaning operation of the filter element can be performed after the dust suction is completed each time. Alternatively, a user can perform the self-cleaning operation after the dust suction several times, and can use according to his/her habits.

When the user needs to perform the self-cleaning operation on the filter element 7, the blower motor 8 can be activated separately, the blower motor 8 directly blows air through the channel 12 between the filter element 7 and the suction inlet 11, the air blows toward the filter element 7, the air flows outward from the inner surface of the filter element 7, and when the air passes through the filter element 7, the dust and impurities attached to the surface of the filter element can be removed. Alternatively, the vibration cleaning mechanism can be activated first to drive the filter element to vibrate, such that the dust and impurities attached to the surface of the filter element can be removed by vibration, then the blower motor is activated again to blow away the dust and prevent the dust from being reattached to the surface of the filter element, thereby achieving the self-cleaning effect. The user does not need to frequently disassemble for cleaning or replace the filter element, thereby reducing use costs while enhancing user experience.

It should be noted that the above is only a preferred embodiment of the present disclosure, and is not intended to limit the present disclosure. Although the present disclosure has been described in detail with reference to the above embodiment, for those skilled in the art, it is still apparent that the technical solutions described in the above embodiment may be modified, or some technical features thereof may be equivalently replaced. Any modifications, equivalent replacements, improvements, etc. made within the spirit and principles of the present disclosure shall fall within the protection scope of the present disclosure.

1. A vacuum cleaner with a self-cleaning function, comprising:
a dust cup, wherein the dust cup is provided with an air inlet, and the air inlet is connected to an air intake duct;
a host, wherein a suction assembly and a control assembly are arranged in the host, the host is provided with an air outlet and a suction inlet, the dust cup is connected to the host, and the suction assembly is connected to the control assembly;
a filter element, wherein the filter element is mounted in the dust cup, a channel is formed between the filter element and the suction inlet of the host, and external dusty air enters the dust cup through the air intake duct and then enters the host after flowing through the filter element and is discharged outward through the air outlet of the host;
and a dust-blowing cleaning mechanism, wherein the dust-blowing cleaning mechanism is arranged in the channel between the filter element and the host, the dust-blowing cleaning mechanism blows out clean air, and the clean air passes through the filter element and blows off dust and impurities from a surface of the filter element.

2. The vacuum cleaner with a self-cleaning function according to claim 1, wherein the channel formed between the filter element and the suction inlet of the host is a sealed space, and air can only pass through the filter element.

3. The vacuum cleaner with a self-cleaning function according to claim 1, wherein the channel formed between the filter element and the suction inlet of the host has gaps, and the air passes through both the gaps and the filter element.

4. The vacuum cleaner with a self-cleaning function according to claim 1, wherein the dust cup is provided with a filter cartridge support, a top of the filter cartridge support is connected to the host, a filter net is arranged on a side wall of the filter cartridge support, the filter element is located in the filter cartridge support, and external dusty air enters the filter element after passing through the filter net.

5. The vacuum cleaner with a self-cleaning function according to claim 1, wherein the dust-blowing cleaning mechanism comprises a blower motor, the blower motor is provided with an air duct, and the air duct penetrates through both ends of the blower motor.

6. The vacuum cleaner with a self-cleaning function according to claim 5, wherein a motor support is arranged on the host, the blower motor is mounted in the motor support, and the motor support extends into the channel.

7. The vacuum cleaner with a self-cleaning function according to claim 5, wherein the blower motor comprises an inner shell and an outer shell, the inner shell and the outer shell are connected by a connecting rib, and the air duct is formed between the inner shell and the outer shell.

8. The vacuum cleaner with a self-cleaning function according to claim 1, wherein the dust cup is provided with a vibration cleaning mechanism, the vibration cleaning mechanism is connected to the control assembly, and the vibration cleaning mechanism drives the filter element to vibrate.

9. The vacuum cleaner with a self-cleaning function according to claim 8, wherein the vibration cleaning mechanism comprises a vibration motor and an eccentric wheel, the eccentric wheel is connected to a drive shaft of the vibration motor, and the vibration motor drives the eccentric wheel to rotate and intermittently collide with the filter element so as to induce vibration of the filter element.

10. The vacuum cleaner with a self-cleaning function according to claim 9, wherein a bottom surface of the filter element is provided with a bottom cover, a support column is arranged inside the bottom cover, the eccentric wheel is located on a side surface of the support column, the vibration motor drives the eccentric wheel to rotate to periodically collide with the support column at an interval, and the filter element is driven to vibrate; and alternatively, the eccentric wheel and the filter element can directly collide with each other periodically at an interval, such that the filter element vibrates.

11. The vacuum cleaner with a self-cleaning function according to claim 8, wherein the vibration cleaning mechanism comprises a vibration cylinder and a top block, wherein the top block is connected to a piston of the vibration cylinder, and the vibration cylinder drives the top block to move back and forth in a telescopic manner to collide with the filter element, which drives the filter element to vibrate.
